(19) United States
(12) Patent Application Publication
(10) Pub. No.: US 2025/0313688 A1
(43) Pub. Date: Oct. 9, 2025

(54) Rubber composition and rubber article incorporating same

(71) Applicant: HUTCHINSON, Paris (FR)

(72) Inventor: Gwenaëlle BIERCE-ARGY, Ferrières en Gatinais (FR)

(21) Appl. No.: 19/089,223

(22) Filed: Mar. 25, 2025

(30) Foreign Application Priority Data
Apr. 4, 2024 (FR) 2403504

(51) Int. Cl. C08L 23/16; C08K 3/04; C08K 3/34; C08K 5/101; H01M 8/04029; H01M 8/04082; H01M 8/10

(52) U.S. Cl. CPC C08L 23/16; C08K 3/04; C08K 3/346; C08K 5/101; H01M 8/04029; H01M 8/04201; C08K 2201/006; C08K 2201/014; C08L 2203/18; C08L 2205/025; C08L 2205/035; C08L 2205/06; C08L 2207/322; C08L 2312/00; H01M 2008/1095

(57) ABSTRACT

The invention relates to a rubber composition based on at least one EPM copolymer or one EPDM terpolymer, and a rubber article incorporating it, such as a seal or a pipe (10) e.g. for an air, water, or cooling circuit equipping a fuel cell.

The composition comprises:
a filler comprising a carbon black and a lamellar inorganic filler,
a processing aid system,
a plasticizing system, and
a crosslinking system comprising a peroxide,
   wherein the composition comprises, in mass percents:
28-32% of carbon black, which is chosen from the
ASTM N600 or N700 series of blacks, and
those having a specific surface area of 15-25 m²/g, an iodine adsorption index of 16-24 mg/g, and a DBP absorption index of 90-110 mL/100 g,
10-20% of the lamellar inorganic filler,
1.0-6.0% of the processing aid system, which comprises a carbon black covering agent, and
10-22% of the plasticizing system.

### TECHNICAL FIELD

The invention relates to a rubber composition based on at least one ethylene propylene copolymer (EPM) or one ethylene propylene diene terpolymer (EPDM), and a rubber article, such as a hose or a seal, incorporating this composition. The invention applies in particular to a single-layer or multi-layer hose for conveying a fluid under pressure, the fluid being a liquid, a gas, a mixture of gases, or a supercritical fluid. The invention applies in particular to such a hose for a circuit for humidified air, ultrapure water, or coolant, equipping a fuel cell (e.g. a proton-exchange membrane fuel cell PEMFC such as a hydrogen fuel cell), for example for an FCEV (fuel cell electric vehicle which may be a passenger vehicle, a heavy vehicle, or an agricultural or construction vehicle), or for an electric vehicle for use on rails, in water, or in the air or in space, or to such a hose for an industrial facility.

### PRIOR ART

As is known, a hose for a cooling circuit of a motor vehicle heat engine may be single-layer or multi-layer depending on the pressure of the fluid conveyed, and in the multi-layer case may be reinforced, for example by a textile reinforcement (on top of an internal rubber layer and with an external rubber layer on top of it, exposed to the air surrounding the hose). The rubber of the hose, with which the circulating coolant (usually glycol water) is in contact, is generally based on at least one ethylene propylene diene terpolymer (EPDM), due to the reduced physicochemical affinity of EPDM for the water-ethylene glycol mixture, which prevents the rubber from swelling and gives it satisfactory impermeability to this coolant.

Rubber hoses used in a cooling circuit equipping a hydrogen fuel cell of an FCEV electric motor vehicle also convey a coolant of the glycol water type, consequently having the same two requirements for the single or internal layer of the hose: having satisfactory resistance to swelling and satisfactory impermeability during contact with this liquid. However, the rubber compositions of the single or internal layer of hoses for coolant, ultrapure water, and humidified air circuits connected to a hydrogen fuel cell must also satisfy other cumulative requirements, including those set forth below.

A first requirement to be met by these compositions is that they must generate a minimized release of ions to the circulating aqueous fluid, to which their initial reduced ionic conductivity must remain low (even after prolonged contact with this fluid), in order to avoid short circuits. However, one disadvantage of the usual compositions based on EPDM is that they are often likely to release into the fluid a high amount of metal ions originating from some of the additives used in addition to EPDM.

A second requirement to be met by these compositions is that they must also contribute to the electrical insulation of the hydrogen fuel cell, the materials used therefore needing to be highly resistive by having a maximized volume electrical resistivity, ideally greater than or equal to 1.0×10⁸ Ohm-cm. However, a disadvantage of the usual compositions based on EPDM is that they sometimes have insufficient volume resistivities, situated in an intermediate zone referred to as “percolation”, i.e. between 10⁴ and 10⁸ Ohm-cm.

Document EP 1 291 566 B1 discloses a rubber composition for a hose equipping a fuel cell in particular, the composition being presented as generating minimized contamination for the transported fluid and maximized volume resistivity. The composition comprises (A) at least one rubber selected among an EPM, an EPDM, and a silicone rubber, (B) 1-10 phr of a peroxide as the sole crosslinking agent, and (C) 20-130 phr of a filler having a laminar crystalline structure, where phr designates parts by weight per 100 parts of (A). The composition in Example 7 comprises (mass percents) 29.48% of an EPDM, 1.24% of a peroxide crosslinking system, 29.48% of “Asahi No. 52” carbon black, 22.11% of kaolinite, and 17.69% of a paraffinic plasticizer, for a measured volume resistivity of the composition of 2×10¹¹ Ohm-cm and an electrical conductivity for pure water of 14.4 μS/cm after 168 hours of heat treatment applied to a 50 g sheet of the rubber composition, immersed in 250 mL of pure water at 100° C.

A disadvantage of the compositions presented in EP 1 291 566 B1 is that they do not comprise the slightest additive to aid in their processing, which adversely impacts their extrudability in particular, and thus does not render them usable for forming pipes under satisfactory conditions.

Another disadvantage of the compositions presented in EP 1 291 566 B1 is that the electrical conductivity measurements described in this relatively old document do not satisfy the conditions adopted in recent years to ensure the reliability of conductivity measurements after aging. Indeed, that document does not disclose the dimensions of the samples tested (the length, width, and thickness of the rubber sheets are unknown), which does not allow us to know the ratio of exposed rubber surface area/volume of water, which is decisive in an aging test on a sample in contact with a fluid.

### DISCLOSURE OF THE INVENTION

One aim of the present invention is to provide a rubber composition which is usable in particular in a pipe carrying humidified air, an aqueous cooling liquid, or ultrapure water, in connection with a fuel cell, which overcomes the aforementioned disadvantages in particular, while having satisfactory processability in the crosslinkable state as well as satisfactory properties in the crosslinked state, including minimized ion release into an aqueous medium and maximized electrical resistivity.

This aim is achieved in that the Applicant has just discovered, in an unexpected manner in view of the aforementioned prior art, that if specific mass percents of a semi-reinforcing carbon black, a lamellar inorganic filler, a processing aid system including a covering agent for said carbon black, and a plasticizing system are used in a rubber composition based on a peroxide-crosslinkable EPM or EPDM, then it is possible to obtain the single layer of a single-layer pipe or at least one internal layer of a multi-layer pipe having satisfactory processability in the crosslinkable state, and physicochemical and mechanical properties which are equally satisfactory in the crosslinked state, in particular with minimization of the release of ions by the rubber composition into the conveyed fluid in contact with said composition while giving the composition a sufficiently high volume resistivity, thus making this composition particularly well suited for forming a single layer pipe or at least one inner layer of a multi-layer pipe carrying humidified air, an aqueous cooling liquid, or ultrapure water, in connection with a fuel cell.

A rubber composition according to the invention is based on at least one elastomer chosen among the ethylene propylene copolymers (EPM) and the ethylene propylene diene terpolymers (EPDM), and the composition comprises:
a filler comprising carbon black and a lamellar inorganic filler,
a processing aid system,
a plasticizing system, and
a crosslinking system comprising a peroxide, and, according to the invention, the composition comprises (in mass percents):
   28-32% of carbon black, which is chosen from the
   ASTM N600 or N700 series of carbon blacks, and
   carbon blacks having a BET specific surface area of 15-25 m²/g, an iodine adsorption index of 16-24 mg/g according to standard ASTM D1510, and a dibutyl phthalate (DBP) absorption index of 90-110 mL/100 g according to standard ASTM 2414-90,
   10-20% of the lamellar inorganic filler,
   1.0-6.0% of the processing aid system, which comprises a carbon black covering agent capable of binding to the acid functional groups of said carbon black, and
   10-22% of the plasticizer system.

One will note that the processing aid system thus defined contributes to optimizing:
the processability of the composition combined with this plasticizer system, and
the crosslinking of the composition, by covering the acid functions of said carbon black so as to minimize the absorption of peroxide by the carbon black.

One will also note that the mixed filler according to the invention, comprising the aforementioned quantities of carbon black and lamellar inorganic filler, contributes significantly to jointly achieving a minimized release of ionic species by the composition into the aqueous fluid in contact with it, and a volume resistivity which in contrast is very high for said composition.

The expression “based on” in the present description is understood to mean that the composition or ingredient concerned predominantly comprises that composition or ingredient by weight, i.e. in a mass percent that is greater than 50%, preferably greater than 75%, and possibly up to 100%.

One or more EPDMs are advantageously used as the elastomer(s) usable in a composition according to the invention, the or each EPDM possibly being modified, preferably not extended with oil, and having:
a mass concentration of ethylene-derived units of 47-71%, of a non-conjugated diene (such as ethylidene norbornene: ENB) of 3-7%, and preferably
a Mooney viscosity of between 65 and 90 ML(1+4) at 125° C.

Preferably, said at least one EPDM, not extended with oil, has:
a mass concentration of ethylene-derived units of 50-68%, of a non-conjugated diene (such as ENB) of 4.0-6.0%, and preferably
a Mooney viscosity of between 70 and 85 ML(1+4) at 125° C.

For example, it is possible to use a blend of two EPDMs not extended with oil, one having a mass concentration of ethylene-derived units of 47-53% and a Mooney viscosity of between 65 and 75 ML(1+4) at 125° C., and the other having a mass concentration of ethylene-derived units of 65-71% and a Mooney viscosity of between 80 and 90 ML(1+4) at 125° C.

Also preferably, the composition comprises said at least one EPDM elastomer in a mass percent of 25-40% (e.g. 30-35%), preferably comprising a mixture of a first EPDM and a second EPDM having mass concentrations of ethylene-derived units of 48-52% and 66-70% respectively, for example with the mass percents of the first EPDM and the second EPDM in the mixture being 40-60% and 60-40% respectively.

One will note that these compositions according to the invention, based on at least one EPM or EPDM, thus have a high resistivity, in particular due to said lamellar inorganic filler, despite the use of a high amount of carbon black which is known to adversely impact this resistivity (by increasing the electrical conductivity). This high resistivity makes it possible in particular to minimize the electrochemical degradation of the internal layer of the pipe in contact with the fluid it carries, when this fluid is a coolant, for example glycol water, without adversely impacting the resistance of the pipe to its external environment.

“Filler” in the present description is understood to mean several individual fillers of reinforcing or non-reinforcing grades for the elastomer concerned, which are dispersed homogeneously in the composition, and “lamellar inorganic filler” is understood to mean a mineral filler (sometimes called “white filler” or “clear filler”) having a lamellar structure, as opposed to organic fillers such as carbon blacks and non-lamellar inorganic fillers such as silicas.

Preferably, said carbon black (i.e. of the ASTM N600 or N700 series, or having a BET surface area of 15-25 m²/g, an iodine adsorption index of 16-24 mg/g, and a DBP absorption index of 90-110 mL/100 g) is present in the composition in a mass percent of 28.5-31.5%, or even 29.0-31.0%.

Even more preferably, the carbon black according to the invention belongs to the ASTM N600 series (and can then correspond to or be similar to ASTM N650 or N660 grade blacks), or it has a BET specific surface area of 17-23 m²/g, an iodine adsorption index of 18-22 mg/g according to ASTM D1510, and a DBP absorption index of 95-105 mL/100 g according to ASTM 2414-90.

“Lamellar inorganic filler” is understood here to mean an inorganic filler which has an aspect ratio that is greater than 10, preferably greater than 20, given that “aspect ratio” is understood to mean, in a known manner, the ratio of the largest average dimension (usually width or length) to the smallest average dimension (usually thickness) characterizing the lamellae of the inorganic filler. This average ratio can be measured by scanning electron microscopy (SEM).

Advantageously, the lamellar inorganic filler may be selected among the phyllosilicates and talcs.

“Phyllosilicate” is understood to mean, in a known manner, a subgroup of the silicate group, phyllosilicates being constructed by stacking tetrahedral layers (“T”) where the tetrahedra share three vertices out of four (the “basal” oxygens), the fourth vertex (the “apical” oxygen) being connected to an octahedral layer (“O”) occupied by different cations. Suitable phyllosilicates include, for example, smectites, kaolinite and kaolins, micas, vermiculites, and montmorillonites.

In a known manner, the following meanings are understood:
“kaolinite”: a mineral species of phyllosilicate composed of hydrated aluminosilicate, of formula Al₂Si₂O₅(OH)₄;
“mica”: a mineral group within the phyllosilicates, mainly based on aluminum silicate and potassium silicate; and
“talc”: a mineral species essentially composed of doubly hydroxylated magnesium silicate, of formula Mg₃Si₄O₁₀(OH)₂.

Preferably, the lamellar inorganic filler of the composition according to the invention comprises a kaolin, a mica, or a talc, which is present in the composition in a mass percent of 12-18%, more preferably 13-17%, and for example 14-16%.

Even more preferably, the lamellar inorganic filler comprises kaolin, for example calcined, in a mass percent of 12-18% in the composition, for example 13-17%, or even 14-16%. The kaolin, preferably calcined at more than 600° C., may in particular have mass percents of SiO₂, Al₂O₃, and Fe₂O₃ of 50-65%, 30-45%, and 0.5-1.5% respectively, and an average particle size d50 of 1-2 μm.

According to a preferred embodiment of the invention, the filler of the composition according to the invention comprises, in combination:
a carbon black of the N600 series, or having a BET specific surface area of 17-23 m²/g, an iodine adsorption index of 18-22 mg/g, and a DBP absorption index of 95-105 mL/100 g, and
a kaolin, a mica, or a talc (preferably a kaolin, for example calcined as described above) as the lamellar inorganic filler.

According to another characteristic of the invention, the filler of said composition may advantageously be without any
non-lamellar inorganic filler, therefore being without any silica or calcium carbonate in particular, and
lamellar inorganic filler provided with silane groups.

As a covering agent capable of binding to acid functional groups of carbon black (of the N600 or N700 series or having a BET specific surface area of 15-25 m²/g, an iodine adsorption index of 16-24 mg/g, and a DBP absorption index of 90-110 mL/100 g), we can mention a polyethylene glycol preferably having a number-average molecular weight Mn of between 3000 and 5000 g/mol inclusively, for example 3500-4500 g/mol.

According to another characteristic of the invention, said processing aid system may further comprise at least one lubricating agent, for example chosen from compounds based on fatty acid esters and for example from aliphatic fatty acid esters having from 14 to 22 carbon atoms.

One will note that said lubricating agent may advantageously perform a function of external lubricant for the rubber composition, thereby ensuring external lubrication of the interface with the processing equipment (e.g. reduced adhesion to the metal surfaces with which the composition comes in contact during its processing, including the surface of the extruder).

Preferably, the composition according to the invention comprises the processing aid system in a mass percent of 1.5-4.0%, this processing aid system then being able to comprise said at least one lubricating agent in addition to said covering agent.

More preferably, the processing aid system consists of said at least one lubricating agent and said covering agent, and may then be present in the composition in a mass percent of 2.0-3.5%.

In general, the processing aid system may be without any agent for activating the crosslinking system (the composition then advantageously being without any zinc oxide or stearic acid).

For a plasticizing system that is usable in the invention, a plasticizing oil and/or a plasticizing resin may be used, given that the plasticizing system is preferably present in the composition in a mass percent of 12-20% (more preferably 14-18%), and may advantageously comprise a high-viscosity oil (with a kinematic viscosity of at least 30 mm²/s at 100° C., measured according to the ASTM D 445 standard).

As a variant of this high-viscosity oil, at least one oil selected among mineral oils (e.g. paraffinic, naphthenic, and/or aromatic), oils derived from biomass (including modified or unmodified vegetable oils), and mixtures thereof, may be used.

One will note that the processing aid system as defined above, together with the aforementioned filler and plasticizing system, makes it possible to give the crosslinkable composition according to the invention a reduced Mooney viscosity ML(1+4) at 100° C. while preventing premature crosslinking (scorching), thus making the composition of the invention suitable for processing by extrusion, due to its satisfactory visual appearance with an absence of holes, cracks, and shrinkage of the extrudate.

According to another characteristic of the invention, the composition may comprise the crosslinking system in a mass percent of 2.5-4.0% (preferably 3.0-3.5%), which comprises an organic peroxide and a crosslinking co-agent, e.g. triallyl cyanurate (TAC) or triallyl isocyanurate (TAIC).

One will note that this co-agent allows significantly improving the crosslinking by the peroxide and therefore the mechanical and physical properties of the composition, in comparison to a control composition crosslinked with no co-agent added to the same organic peroxide.

A composition according to the invention may further comprise an antioxidant system comprising at least one antioxidant, preferably a heterocyclic aromatic (e.g. based on polymerized 2,2,4-trimethyl-1,2-dihydroquinoline).

According to another characteristic of the invention, the composition may advantageously have a volume resistivity in the crosslinked state, measured according to standard IEC 62631-3, which is greater than or equal to 1.0×10⁸ Ohm-cm, preferably greater than or equal to 1.0×10⁹ Ohm·cm.

One will note that this very high volume resistivity of the rubber composition according to the invention allows it to contribute effectively to the electrical insulation of the fuel cell, in which at least one of the humidified air, water, and cooling circuits is equipped with a pipe incorporating this composition.

According to another characteristic of the invention that may be combined with the previous one, after aging samples consisting of the crosslinked composition, by immersion for 2 to 4 weeks at 80° C. in a volume of an aqueous liquid chosen among ultrapure water and water-ethylene glycol mixtures, with a ratio of the surface area of the sheet/volume of the aqueous liquid set to 30 mm²/mL and the samples being cut with a 40×60 mm punch from a sheet having a thickness of 2.0±0.2 mm, the aqueous liquid advantageously may have a final ionic conductivity Cf that is less than or equal to its initial ionic conductivity Ci (before said immersion) plus 10 μS/cm: Cf−Ci≤10 μS/cm, and preferably Cf−Ci≤8 μS/cm when the aqueous liquid is ultrapure water.

One will note that this minimal difference in ionic conductivity for the aqueous liquid before and after said aging carried out according to this well-defined and reproducible protocol, demonstrates a minimization of the release of ions by the rubber composition into the aqueous liquid conveyed and in contact therewith, which contributes to avoiding short circuits in the fuel cell system.

According to another general aspect of the invention, a rubber article according to the invention is chosen among pipes for transferring a liquid, gaseous, or supercritical fluid under pressure, and seals, the article comprising or consisting of a rubber composition extruded in the crosslinkable state and then crosslinked, as defined by any one of the above characteristics.

Preferably, the article is a pipe for a circuit connected to a fuel cell and carrying humidified air, a water-ethylene glycol coolant, or ultrapure water, and the pipe is then:
single-layer, consisting of said rubber composition, or
multi-layer, comprising a radially internal layer consisting of said rubber composition, at least one reinforcing layer on top of it, and a radially external covering layer.

Even more preferably, the pipe is configured to convey ultrapure water or a water-ethylene glycol coolant, and is such that:
the rubber composition has a volume resistivity in the crosslinked state, measured according to standard IEC 62631-3, which is greater than or equal to 1.0×10⁸ Ohm-cm, preferably greater than or equal to 1.0×10⁹ Ohm-cm, and
after aging samples consisting of the crosslinked rubber composition, by immersion for 2 to 4 weeks at 80° C. in a volume of an aqueous liquid chosen among ultrapure water and water-ethylene glycol mixtures, with a ratio of the surface area of each sample/volume of the aqueous liquid set to 30 mm²/mL and the samples being cut with a 40×60 mm punch from a sheet having a thickness of 2.0±0.2 mm, said aqueous liquid has a final ionic conductivity Cf that is less than or equal to its initial ionic conductivity Ci (before said immersion) plus 10 μS/cm: Cf−Ci≤10 μS/cm, and preferably Cf−Ci≤8 μS/cm when the aqueous liquid is ultrapure water.

According to yet another general aspect of the invention, said crosslinkable rubber composition may be prepared by implementing a process essentially comprising the following successive steps:
a) introducing the ingredients of the composition, except for the crosslinking system, into an internal mixer;
b) thermomechanically working the ingredients, in one step in this internal mixer, until a maximum “drop” temperature is reached, for example 120-130° C.;
c) retrieving and then cooling the mixture thus obtained; then
d) adding the crosslinking system to the peroxide in an external mixer (e.g. rolling mill) at a temperature of 95-105° C., while mechanically working the crosslinkable composition thus obtained in this external mixer.

Alternatively, the crosslinking system may be introduced during step b), or during a second introduction into the internal mixer after cooling the precursor mixture resulting from the first step.

### BRIEF DESCRIPTION OF DRAWINGS

Other features, details and advantages of the invention will emerge from reading the following description of some exemplary embodiments of the invention, provided for illustrative purposes in relation to the attached drawings, which include:

FIG. 1 is a schematic side perspective view of a single-layer pipe according to the invention.

FIG. 2 is a schematic side perspective view with partial cutaways of a multi-layer pipe according to one example of the invention.

FIG. 3 is a schematic side perspective view with partial cutaways of a multi-layer pipe according to another example of the invention.

FIG. 4 is a schematic side perspective view with partial cutaways of a multi-layer pipe according to another example of the invention.

FIG. 5 is a schematic side perspective view with partial cutaways of a multi-layer pipe according to another example of the invention.

FIG. 6 is a schematic view of a fuel cell system, in which at least one of the humidified air, cooling, and water circuits connected thereto comprises a single-layer or multi-layer pipe according to the invention.

### EXEMPLARY EMBODIMENTS OF THE INVENTION

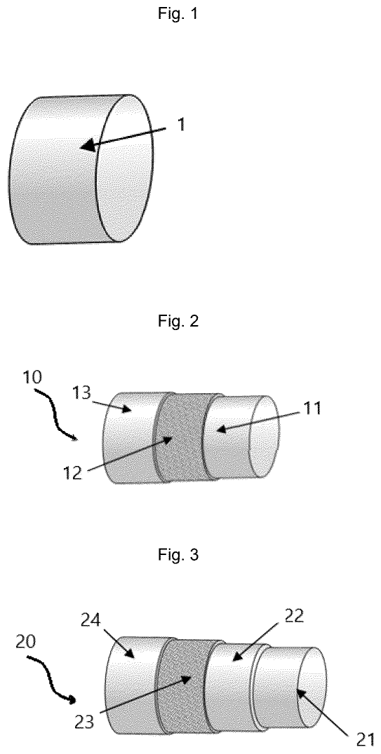

Single-layer pipe 1 of FIG. 1 is, for example, capable of conveying a fluid at a pressure of at most 3×10⁵ Pa and a temperature of at most 120° C., and it may be assembled to two connectors, for example thermoplastic ones. Pipe 1 is formed of a composition according to the invention as defined above.

Multi-layer pipe 10 of FIG. 2 is, for example, capable of conveying a fluid at a pressure that may be greater than or equal to 3×10⁵ Pa, and it comprises a radially internal tube 11, a reinforcing layer 12, and a radially external covering layer 13, with at least tube 11 being formed of a composition according to the invention as defined above.

Reinforcing layer 12 may comprise, without limitation, a knit, braid, or sheath based on multifilament yarns made of one or more textile material(s), for example a polyamide (e.g. aramid), polyester (e.g. PET), or rayon (the term “yarn” usually designating both a yarn based on a multitude of elementary filaments of small diameter which are twisted together, and a multi-ply yarn obtained by twisting several yarns together).

Multi-layer pipe 20 of FIG. 3 is distinguished from that of FIG. 2 in that internal tube 21 is surmounted by an intermediate layer 22 which itself is surmounted by a reinforcing layer 23 covered with a covering layer 24, with at least tube 21 being formed of a composition according to the invention.

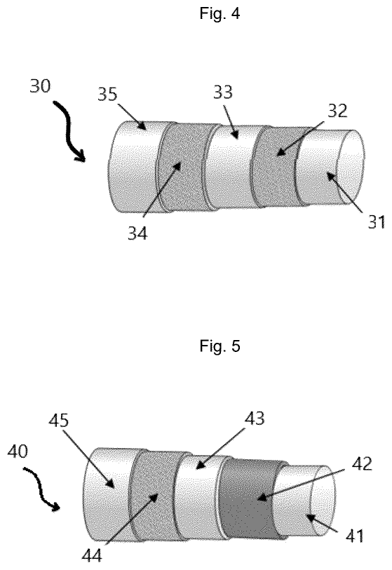

Multi-layer pipe 30 of FIG. 4 differs from that of FIG. 3 in that the internal tube 31 is surmounted by an internal reinforcing layer 32 which itself is surmounted by an intermediate layer 33 covered with an external reinforcing layer 34 and then with a covering layer 35, with at least tube 31 being formed of a composition according to the invention.

Multi-layer pipe 40 of FIG. 5 differs from that of FIG. 3 in that internal tube 41 is surmounted by a barrier layer 42 made of plastic forming an insulating layer, then by an intermediate layer 43 covered with a reinforcing layer 44, which itself is surmounted by a covering layer 45, with at least tube 41 being made of a composition according to the invention.

One will note that a multi-layer pipe according to the invention could comprise an arrangement of layers that differs from those illustrated in FIGS. 2-5, both by the number of its layers and by their respective functions.

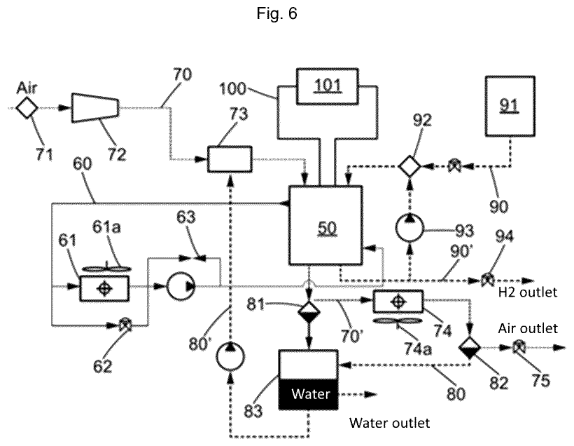

The fuel cell system illustrated in FIG. 6, without limitation, essentially comprises, around and in connection with a fuel cell 50 such as a hydrogen cell for example of the “PEMFC” type:
a closed cooling loop 60 conveying a coolant comprising for example a water-ethylene glycol mixture, which in particular comprises a condenser 61 equipped with a fan 61a, a control valve 62, and a check valve 63;
an air loop 70, 70′ conveying air, which comprises, downstream of a filter 71 and a compressor 72, a humidifier 73 bringing (portion 70) humidified air into fuel cell 50, and extracting it from said cell (portion 70′) towards air/water separators 81 and 82 respectively located upstream and downstream of a condenser 74 equipped with a fan 74a receiving the air exiting the upstream air/water separator 81, the air outlet from the downstream air/water separator 82 leading to an air outlet from the system via a control valve 75;
a water loop 80, 80′ extending (portion 80) from the respective water outlets of the upstream 81 and downstream 82 separators to a water tank 83 provided with the water outlet of the system and a line 80′ for supplying water to humidifier 73;
a hydrogen loop 90, 90′ comprising a portion 90 extending from a hydrogen tank 91 to fuel cell 50 via a filter 92, with recirculation 93 of the hydrogen exiting fuel cell 50 towards filter 92 and towards a portion 90′ leading to the hydrogen outlet of the system via a control valve 94; and
an electrical circuit 100 comprising a power unit 101 connected to fuel cell 50.

One will note that pipes according to the invention could be incorporated into at least one among the cooling, air, and water circuits equipping a fuel cell, but the or each circuit incorporating these pipes may possibly have characteristics different from those of FIG. 6.

Preparation of a Rubber Composition I1 According to the Invention and of “Control” Compositions C1, C2 and C3 not in Accordance with the Invention:

Each of the rubber compositions I1 and C1-C3 were prepared essentially by implementing the following process.

The ingredients of each composition, with the exception of the crosslinking system, were introduced into a Banbury® type of internal mixer. The ingredients were thermomechanically worked in one step (kneading time: 30 s to 2 min.), until a maximum “drop” temperature of about 125° C. was reached.

The mixture thus obtained was retrieved, cooled, and then the crosslinking system was added to an external mixer (rolling mill) at 100° C., mixing the whole for about 2 min. in a mechanical working step.

Each crosslinkable rubber composition thus obtained was shaped into cylindrical test pieces for measuring properties in the uncrosslinked state (Mooney viscosity ML(1+4) at 100° C. according to ISO 289-1, and scorch time t5 without premature crosslinking at 135° C. according to ISO 289-2), and into dumbbell-type test pieces for measuring physical and mechanical properties in the crosslinked state after curing the test pieces at 180° C.

In particular, the following were measured on the dumbbell-type test pieces respectively made up of crosslinked compositions I1 and C1-C3:
hardness in IRHD (International Rubber Hardness Degrees) units, according to ISO 48:2010,
breaking stress Cr and elongation at break Ar, under uniaxial traction according to ISO 37:2017, and
volume electrical resistivity at 1000 V according to standard IEC 62631 3.

In addition, measurements were made of the ionic conductivity of ultrapure water (with an initial ionic conductivity Ci of less than 1.0 μS/cm), after aging samples consisting of each crosslinked composition I1 and C1-C3, by immersion in a volume of this ultrapure water for 2 to 4 weeks at 80° C., with a ratio of sheet surface area/aqueous liquid volume set to 30 mm²/mL (the volume of water being adjusted in the bottles to maintain this ratio) and cutting the samples with a 40×60 mm punch from a sheet having a thickness of 2.0±0.2 mm, measuring the difference ΔC=Cf−Ci between the final ionic conductivity Cf and the initial ionic conductivity Ci of the ultrapure water, respectively after and before said immersion.

In particular, a “Mettler Toledo—Five Easy F30” conductivity meter with a “Mettler Toledo—INLAB 720” conductivity cell (measuring range of 0.01-500 μS/cm, after initial calibration of the conductivity meter) and 250 mL bottles with GL45 caps were used for this purpose (the bottles were rinsed each time with ultrapure water and dried with Joseph paper). For each test, three samples from a same sheet were used, the thickness being measured by a 5-point method (resulting in a considered average thickness).

Each bottle was filled with 175 mL of ultrapure water, to obtain the ratio of sheet surface area/water volume of 30 mm²/mL, then a first conductivity measurement Ci was carried out on the water alone in each bottle. Next, the first sheet of each crosslinked composition (previously rinsed) was introduced into a first bottle, which was capped and shaken for a few seconds. The first conductivity measurement was made immediately after immersion, then a second sample of the same crosslinked composition was inserted into another bottle, and so on for all compositions I1 and C1-C3 tested.

The aforementioned aging was carried out for 2 to 4 weeks, with the bottles containing the immersed test samples being placed in an oven at 80° C. after each measurement of the final conductivity Cf, given that before each measurement after the aging, each bottle was removed from the oven and placed for 4 hours at 23° C. in a cooling chamber.

Table 1 below details the respective formulations of compositions I1 and C1-C3 (in phr: parts by weight per 100 parts of EPDM elastomers),

TABLE 1

| | I1 | C1 | C2 | C3 |
|---|---|---|---|---|
| EPDM 1 * | 50 | 30 | 50 | 30 |
| EPDM 2 * | 50 | 70 | 50 | 70 |
| Carbon black ASTM N600 series * | 95 | 110 | 75 | 75 |
| Calcined kaolin * | 45 | 29 | 50 | 50 |
| Plasticizing oil * | 50 | 54 | 35 | 35 |
| Covering agent: PEG 4000 | 2.8 | 2.8 | 2.8 | 2.8 |
| Lubricating agent * | 4.6 | 4.6 | 4.6 | 4.6 |
| Quinoline antioxidant | 1.2 | 1.2 | 1.2 | 1.2 |
| TAC co-agent | 0.7 | 0.7 | 0.7 | 0.7 |
| Organic bis-peroxide | 9.4 | 9.4 | 9.4 | 9.4 |
| TOTAL (parts by weight) | 308.7 | 311.7 | 278.7 | 278.7 |

The ingredients labeled with the symbol * in Table 1 had the following characteristics:
EPDM 1: mass concentration of ethylene-derived units of 50%, of ethylidene norbornene-derived units of 5.0%, and Mooney viscosity of 70 ML(1+4) at 125° C.
EPDM 2: mass concentration of ethylene-derived units of 68%, of ethylidene norbornene-derived units of 4.9%, and Mooney viscosity of 85 ML(1+4) at 125° C.
Carbon black with a BET specific surface area according to ASTM D 6556 of approximately 20 m²/g, an iodine adsorption index according to ASTM D 1510 of approximately 20 mg/g, and a DBP absorption index according to ASTM 2414-90 of approximately 100 mL/100 g.
Calcined kaolin comprising mass percents of SiO₂, Al₂O₃, and Fe₂O₃ of 55-60%, 35-40%, and 0.5-1.0% respectively, and an average particle size d50 of between 1.0 and 1.5 μm.
Plasticizing oil: oil with a kinematic viscosity of between 30 and 40 mm²/s at 100° C., measured according to ASTM D 445.
Lubricating agent: mixture of aliphatic fatty acid esters.

Table 2 below gives the mass percents (in %) of the ingredients of Table 1 in each composition I1 and C1-C3.

TABLE 2

| | I1 | C1 | C2 | C3 |
|---|---|---|---|---|
| EPDM 1 * | 16.20 | 9.62 | 17.94 | 10.76 |
| EPDM 2 * | 16.20 | 22.46 | 17.94 | 25.12 |
| Carbon black ASTM N600 series * | 30.77 | 35.29 | 26.91 | 26.91 |
| Calcined kaolin * | 14.58 | 9.30 | 17.94 | 17.94 |
| Plasticizing oil * | 16.20 | 17.32 | 12.56 | 12.56 |
| Covering agent: PEG 4000 | 0.91 | 0.90 | 1.00 | 1.00 |
| Lubricating agent * | 1.49 | 1.48 | 1.65 | 1.65 |
| Quinoline antioxidant | 0.39 | 0.38 | 0.43 | 0.43 |
| TAC co-agent | 0.22 | 0.23 | 0.25 | 0.25 |
| Organic bis-peroxide | 3.04 | 3.02 | 3.38 | 3.38 |
| TOTAL (%) | 100.00 | 100.00 | 100.00 | 100.00 |

Table 3 below presents the essential rheological properties of the obtained compositions I1 and C1-C3, including, for each of them:
the Mooney viscosity ML(1+4) at 100° C., measured according to ISO 289-1;
the initial scorch time t5 without premature crosslinking, according to ISO 289-2; and
the extrudability in the form of a pipe (including the behavior and appearance of the extrudate consisting of the crosslinkable composition).

TABLE 3

| | I1 | C1 | C2 | C3 |
|---|---|---|---|---|
| ML(1 + 4) at 100° C. | 72.0 | 73.6 | 81.0 | 82.0 |
| Scorch time t5 (min.) at 135° C. | 14.8 | 22.4 | 14.4 | 13.4 |
| Extrudability | Good | Good | Poor | Poor |

“Good” indicated a satisfactory appearance (smooth), no holes, cracks, or fissures, and no shrinkage of the extrudate.
“Poor” indicated an unsatisfactory appearance, with holes, cracks, or fissures, and significant shrinkage of the extrudate.

Table 4 below shows the physical and mechanical properties of the obtained crosslinked compositions I1 and C1-C3, measured as indicated above on dumbbell-type test pieces.

TABLE 4

| | I1 | C1 | C2 | C3 |
|---|---|---|---|---|
| Volume electrical resistivity (Ohm-cm) | 1.0 × 10⁹ | 2.4 × 10⁵ | 4.7 × 10⁸ | 1.3 × 10⁸ |
| Difference in ionic conductivity of pure | 7.2 | 5.1 | 6.2 | 8.2 |
| water after 2 weeks ΔC = Cf − Ci (μS/cm) | | | | |
| Hardness in IRHD (units) | 65 | 65 | 65 | 69 |
| Breaking stress Cr (MPa) | 11.2 | 12.5 | 11.9 | 12.8 |
| Elongation at break Ar (%) | 444 | 400 | 398 | 399 |

The properties obtained in Tables 3 and 4 show that composition I1 according to the invention has, compared to the control compositions C1-C3:
in the crosslinkable state: improved processability, as shown by the minimum Mooney viscosity ML(1+4) for a comparable scorch time t5 and by the satisfactory visual appearance of the extrudate with an absence of holes, cracks, and shrinkage after extrusion, and
in the crosslinked state: physicochemical and mechanical properties which are also improved, in particular with:
a maximal volume resistivity (approximately 1.0×10⁹ Ohm-cm) combined with reduced ion release into the fluid in contact with it, and improved rupture properties for a similar hardness (see the significantly improved elongation-at-break for a comparable similar breaking stress).

These generally improved properties are due in particular to the specific mass percents in the composition according to the invention:
said carbon black (between 28% and 32%, unlike the mass percents of 35.29% and 26.91% used in compositions C1-C3), and
other ingredients, in particular including the mass percents of the elastomer matrix, the lamellar inorganic filler, the processing aid system (comprising the covering agent and the lubricating agent), and the plasticizing system.

These improved properties make the compositions according to the invention particularly well-suited for forming in particular:
a single-layer pipe or at least one internal layer of a multi-layer pipe conveying humidified air, an aqueous cooling liquid, or ultrapure water, in connection with a fuel cell, and
all or part of a seal, for example for the body of a motor vehicle or for a building.

1. Rubber composition, usable in particular in a pipe (1, 10, 20, 30, 40) for humidified air, aqueous cooling liquid, or ultrapure water and connected to a fuel cell (50), the composition being based on at least one elastomer chosen among the ethylene propylene copolymers (EPM) and the ethylene propylene diene terpolymers (EPDM), and comprising:
a filler comprising a carbon black and a lamellar inorganic filler,
a processing aid system,
a plasticizing system, and
a crosslinking system comprising a peroxide,
wherein the composition comprises, in mass percents:
28-32% of carbon black, which is chosen from the
ASTM N600 or N700 series of carbon blacks, and
carbon blacks having a BET specific surface area of 15-25 m²/g, an iodine adsorption index of 16-24 mg/g according to standard ASTM D1510, and a DBP absorption index of 90-110 mL/100 g according to standard ASTM 2414-90,
10-20% of the lamellar inorganic filler,
1.0-6.0% of the processing aid system, which comprises a carbon black covering agent capable of binding to the acid functional groups of said carbon black, and
10-22% of the plasticizer system.

2. Rubber composition according to claim 1, wherein the composition comprises said at least one elastomer which is an EPDM in a mass percent of 25-40%, the composition preferably comprising a mixture of a first EPDM and a second EPDM having mass concentrations of ethylene-derived units of 48-52% and 66-70% respectively,
and for example wherein the mass percents of the first EPDM and the second EPDM in said mixture are 40-60% and 60-40% respectively.

3. Rubber composition according to claim 1, wherein said covering agent comprises a polyethylene glycol, which preferably has a number-average molecular weight Mn of between 3000 and 5000 g/mol inclusively.

4. Rubber composition according to claim 1, wherein said processing aid system further comprises at least one lubricating agent, for example chosen from compounds based on fatty acid esters and for example from aliphatic fatty acid esters having from 14 to 22 carbon atoms.

5. Composition according to claim 1, wherein the composition comprises the processing aid system in a mass percent of 1.5-4.0%, which is preferably without any agent for activating the crosslinking system, the composition being for example without any zinc oxide or stearic acid.

6. Rubber composition according to claim 1, wherein the lamellar inorganic filler is selected among phyllosilicates and talcs, and preferably wherein the lamellar inorganic filler comprises a kaolin, a mica, or a talc, which is present in the composition in a mass percent of 12-18%.

7. Rubber composition according to claim 6, wherein the lamellar inorganic filler consists of a calcined kaolin, and/or said carbon black is of the N600 series or has said BET specific surface area of 17-23 m²/g, said iodine adsorption index of 18-22 mg/g, and said DBP absorption index of 95-105 mL/100 g.

8. Rubber composition according to claim 1, wherein the filler is without any:
non-lamellar inorganic filler, being without any silica or calcium carbonate, and
lamellar inorganic filler comprising silane groups.

9. Rubber composition according to claim 1, wherein the composition comprises the plasticizing system in a mass percent of 12-20%, which preferably comprises an oil having a kinematic viscosity of at least 30 mm²/s at 100° C., measured according to standard ASTM D 445.

10. Rubber composition according to claim 1, wherein the composition comprises the crosslinking system in a mass percent of 2.5-4.0%, which comprises an organic peroxide and a crosslinking co-agent, for example triallyl cyanurate (TAC) or triallyl isocyanurate (TAIC).

11. Rubber composition according to claim 1, wherein the composition has a volume resistivity in the crosslinked state, measured according to standard IEC 62631-3, which is greater than or equal to 1.0×10⁸ Ohm-cm, preferably greater than or equal to 1.0×10⁹ Ohm-cm.

12. Rubber composition according to claim 1, wherein, after aging samples consisting of said composition, by immersion for 2 to 4 weeks at a temperature of 80° C. in a volume of an aqueous liquid chosen among ultrapure water and water-ethylene glycol mixtures, with a ratio of the surface area of the sheet/volume of the aqueous liquid set to 30 mm²/mL and the samples being cut with a 40×60 mm punch from a sheet having a thickness of 2.0±0.2 mm, the aqueous liquid has a final ionic conductivity Cf that is less than or equal to its initial ionic conductivity Ci before said immersion, plus 10 μS/cm:
Cf−Ci≤10 μS/cm, and preferably Cf−Ci≤8 μS/cm when the aqueous liquid is ultrapure water.

13. Rubber article chosen among pipes (1, 10, 20, 30, 40) for transferring a liquid, gaseous, or supercritical fluid under pressure, and seals, wherein the article comprises or consists of a rubber composition according to claim 1, extruded in the crosslinkable state and then crosslinked.

14. Article according to claim 13, wherein the article is a pipe (1, 10, 20, 30, 40) for a circuit (60, 70, 80) connected to a fuel cell (50) and carrying humidified air, a water-ethylene glycol coolant, or ultrapure water, and wherein the pipe (1, 10, 20, 30, 40) is:
single-layer, consisting of said rubber composition, or
multi-layer, comprising a radially inner layer (11) consisting of said rubber composition, at least one reinforcing layer (12) on top of it, and a radially external covering layer (13).

15. Article according to claim 14, wherein the pipe (1, 10, 20, 30, 40) is configured to convey an aqueous liquid consisting of ultrapure water or a water-ethylene glycol coolant, the rubber composition having a volume resistivity in the crosslinked state, measured according to standard IEC 62631-3, which is greater than or equal to 1.0×10⁸ Ohm·cm, preferably greater than or equal to 1.0×10⁹ Ohm·cm, and
after aging samples consisting of said composition, by immersion for 2 to 4 weeks at a temperature of 80° C. in a volume of the aqueous liquid, with a ratio of the surface area of each sample/volume of the aqueous liquid set to 30 mm²/mL and the samples being cut with a 40×60 mm punch from a sheet having a thickness of 2.0±0.2 mm, the aqueous liquid having a final ionic conductivity Cf that is less than or equal to its initial ionic conductivity Ci before said immersion, plus 10 μS/cm: Cf−Ci≤10 μS/cm, and preferably Cf−Ci≤8 μS/cm when the aqueous liquid is ultrapure water.
